(19) United States
(12) Patent Application Publication
(10) Pub. No.: US 2026/0316847 A1
(43) Pub. Date: Oct. 15, 2026

(54) ELECTRICALLY ACTUATED ELEVATING SLED DECK AND CARGO SYSTEM FOR TRUCKS WITH DUAL POWER OPTIONS AND MULTI-PURPOSE FUNCTIONALITY

(71) Applicant: Logan Smith, Lava Hot Springs, ID (US)

(72) Inventor: Logan Smith, Lava Hot Springs, ID (US)

(21) Appl. No.: 19/633,250

(22) Filed: Mar. 30, 2026

Related U.S. Application Data
(60) Provisional application No. 63/786,388, filed on Apr. 10, 2025.

(51) Int. Cl. B62D 33/02; B60J 7/10; B60J 7/16; B60P 1/43

(52) U.S. Cl. CPC B62D 33/0207; B60J 7/104; B60J 7/1607; B60P 1/431

(57) ABSTRACT

An electrically actuated elevating sled deck and cargo system for trucks with dual power options and multi-purpose functionality includes a frame, outer legs coupleable to sides of the frame, a platform, inner legs and rams coupleable to a lower surface of the frame, and a ramp positionable within the frame. The sled deck allows a single person to load and unload the deck from a truck. The sled deck also allows a user to store cargo thereunder when removed from the truck.

### CROSS-REFERENCE TO RELATED APPLICATIONS

This application claims the benefit of U.S. Provisional Application Ser. No. 63/786,388, filed on Apr. 10, 2025, which is incorporated herein by reference.

### TECHNICAL FIELD

The present disclosure relates to a sled deck. More particularly, the present disclosure relates to a sled deck that is electronically elevatable and acts as both a deck to receive snow machines, side-by-sides, etc. and a canopy to protect items positioned thereunder.

### BACKGROUND

Sled decks have been used for years to allow a user to store cargo and off-road vehicles with ease. While users may place cargo and off-road vehicles in the truck bed without a sled deck, there are downsides that arise from performing this action. The major issue with this practice is removing all storage capacity from the truck bed. If the truck were to receive an off-road vehicle, there would not be any space remaining in the bed for additional cargo. Whereas, with sled decks, off-road vehicles may be stored on top of the deck, while cargo is stored below, thereby allowing a user to utilize all the space the bed has to offer.

Sled decks have offered many solutions to the issues discussed above; however, sled decks on the market still have multiple shortcomings. Sled decks are heavy, making them difficult to maneuver, which requires multiple people to load or unload one. Sled decks are also limited to having a single use. That is, they are limited to storing cargo and/or off-road vehicles, and when removed from the truck, require a location to be stored.

Accordingly, there is a need for a sled deck that can be loaded and unloaded by a single person and has multiple functions. The present invention seeks to solve these and other problems.

### SUMMARY OF EXAMPLE EMBODIMENTS

In one embodiment, an electrically actuated elevating sled deck and cargo system for trucks with dual power options and multi-purpose functionality includes a frame, outer legs coupleable to sides of the frame, a platform, inner legs and rams coupleable to a lower surface of the frame, and a ramp positionable within the frame. The frame may include a front beam, a right-side beam that angles downward towards the rear of the sled deck, a left-side beam that mirrors the right-side beam and angled downward towards the rear of the sled deck, and a rear beam. The right-side beam may include a first receiver, and the left-side beam may include a second receiver.

The right-side beam, at a first end, may include a first fastener. The right-side beam, at a second end, may include a second fastener. The left-side beam, at a first end, may include a third fastener. The left-side beam, at a second end, may include a fourth fastener. The first, second, third, and fourth fasteners may be configured to receive the outer legs. A bottom of each of the four outer legs may include a base plate that is secured to the bottom of each leg so as to stabilize each leg. Coupled to an upper surface of the frame may be a platform. The platform may be coupled to the frame via fasteners.

A lower surface of the frame may include the inner legs and the rams. The inner legs may each include a sleeve and an insert positionable into the sleeve. Each of the inner legs may include a base on the bottom of the insert to assist in stabilizing and bearing any load placed on the platform. The rams may include a first ram, a second ram, a third ram, and a fourth ram. Each of the rams may be positioned proximate the inner legs, being proximate each corner of the frame (or positioned in other locations along the frame, being slidable thereon). The rams may have ram legs that descend via a motor and lift the sled deck so a user can easily and unaided remove or insert the sled deck into a truck. A controller may be positioned on the lower surface of the frame. The controller may have buttons that actuate the rams. The controller may be powered by a removably attachable battery or the truck's 12-volt trailer plug, creating a dual power source to operate the sled deck.

To load and unload an off-road vehicle, the user may remove the ramp that is stowed in the frame. The ramp may be configured to be removably attachable to and rest upon the frame.

### BRIEF DESCRIPTION OF THE DRAWINGS

FIG. 1 illustrates a rear, side perspective view of an electrically actuated elevating sled deck and cargo system for trucks with dual power options and multi-purpose functionality;

FIG. 2 illustrates a side perspective view of an electrically actuated elevating sled deck and cargo system for trucks with dual power options and multi-purpose functionality;

FIG. 3 illustrates a rear, side perspective view of an electrically actuated elevating sled deck and cargo system for trucks with dual power options and multi-purpose functionality;

FIG. 4 illustrates a rear, side perspective view of an electrically actuated elevating sled deck and cargo system for trucks with dual power options and multi-purpose functionality;

FIG. 5 illustrates a rear, side perspective view of an electrically actuated elevating sled deck and cargo system for trucks with dual power options and multi-purpose functionality;

FIG. 6 illustrates a rear perspective view of an electrically actuated elevating sled deck and cargo system for trucks with dual power options and multi-purpose functionality;

FIG. 7 illustrates a bottom perspective view of an electrically actuated elevating sled deck and cargo system for trucks with dual power options and multi-purpose functionality;

FIG. 8 illustrates a bottom perspective view of an electrically actuated elevating sled deck and cargo system for trucks with dual power options and multi-purpose functionality;

FIG. 9 illustrates a bottom perspective view of an electrically actuated elevating sled deck and cargo system for trucks with dual power options and multi-purpose functionality;

FIG. 10 illustrates a bottom perspective view of an electrically actuated elevating sled deck and cargo system for trucks with dual power options and multi-purpose functionality;

FIG. 11 illustrates a bottom perspective view of an electrically actuated elevating sled deck and cargo system for trucks with dual power options and multi-purpose functionality;

FIG. 12 illustrates a front, bottom perspective view of an electrically actuated elevating sled deck and cargo system for trucks with dual power options and multi-purpose functionality;

FIG. 13 a front, bottom perspective view of an electrically actuated elevating sled deck and cargo system for trucks with dual power options and multi-purpose functionality;

FIG. 14 illustrates a bottom perspective view of an electrically actuated elevating sled deck and cargo system for trucks with dual power options and multi-purpose functionality;

FIG. 15 illustrates a rear perspective view of an electrically actuated elevating sled deck and cargo system for trucks with dual power options and multi-purpose functionality;

FIG. 16 illustrates a rear, side perspective view of a ramp of an electrically actuated elevating sled deck and cargo system for trucks with dual power options and multi-purpose functionality;

FIG. 17 illustrates a rear, side perspective view of a ramp of an electrically actuated elevating sled deck and cargo system for trucks with dual power options and multi-purpose functionality; and

FIG. 18 illustrates a bottom perspective view of a ramp of an electrically actuated elevating sled deck and cargo system for trucks with dual power options and multi-purpose functionality.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described. Certain terms are used herein, such as “comprising” and “including,” and similar terms are meant to be “open” and not “closed” terms.

As previously described, there is a need for a sled deck that can be loaded and unloaded by a single person and has multiple functions. The present invention seeks to solve these and other problems.

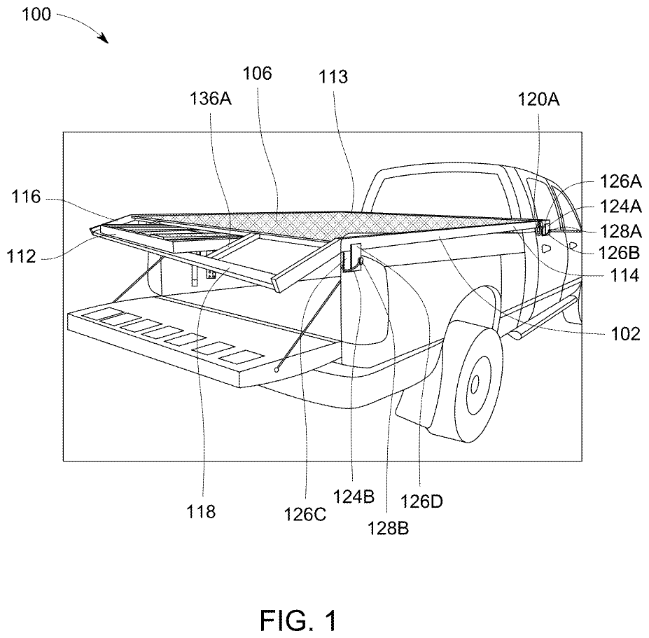

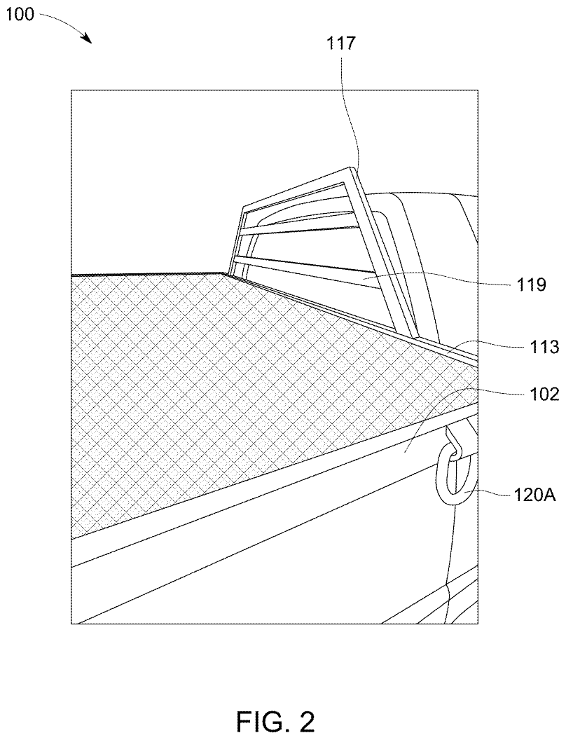

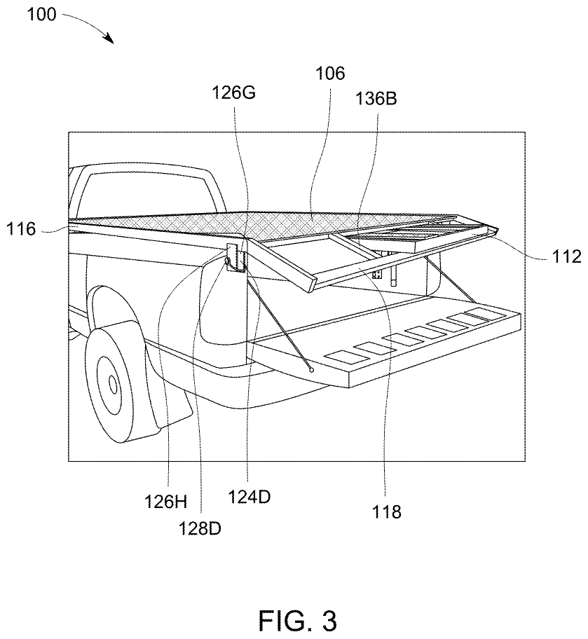

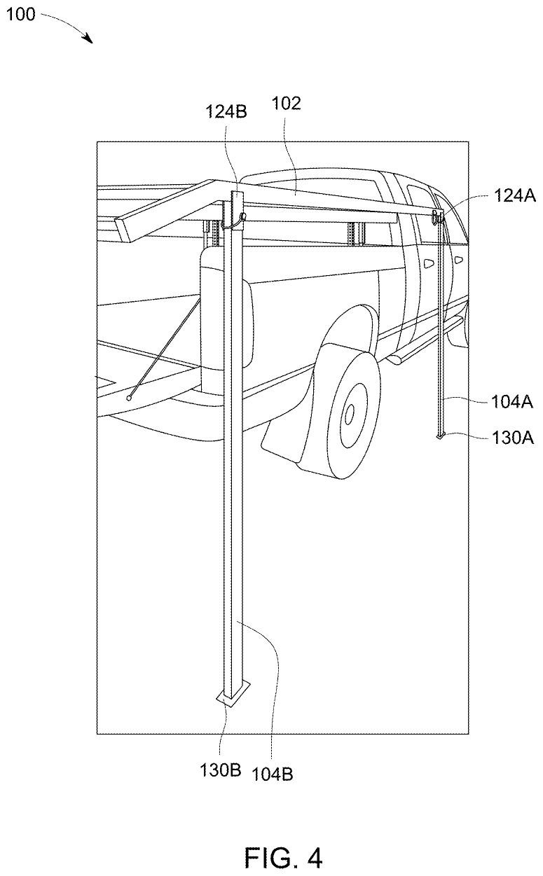

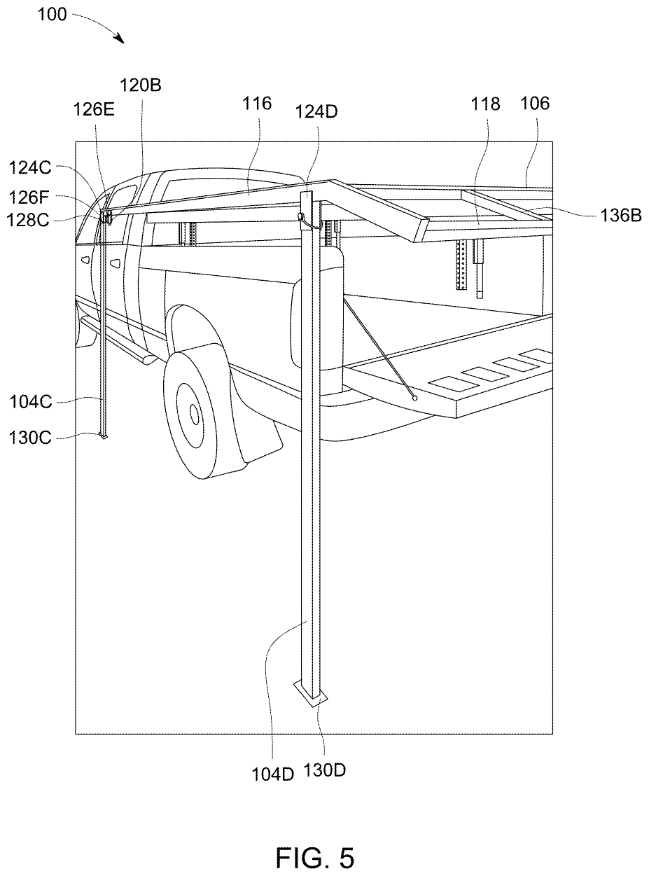

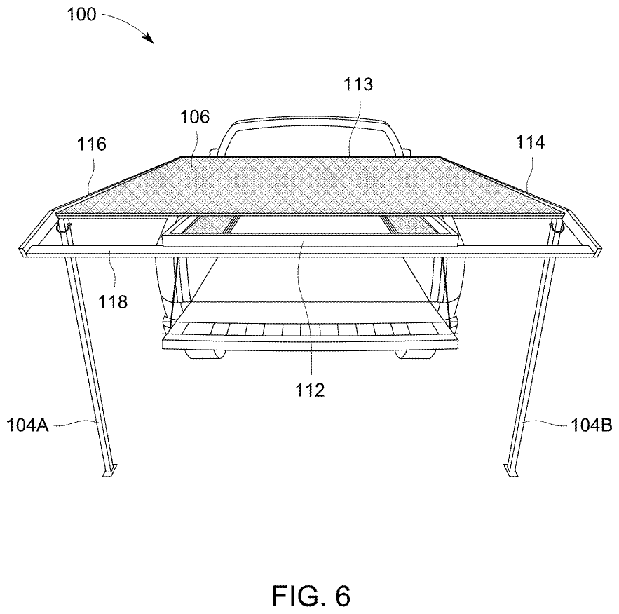

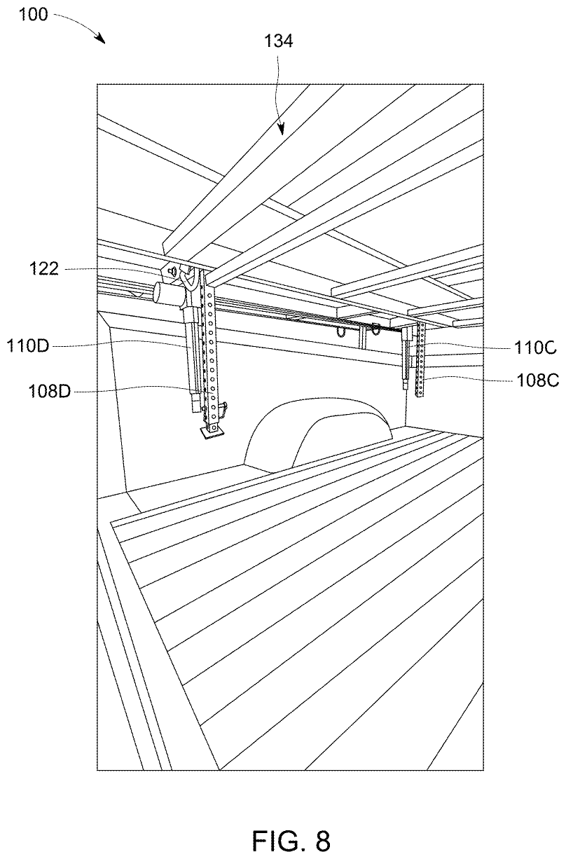

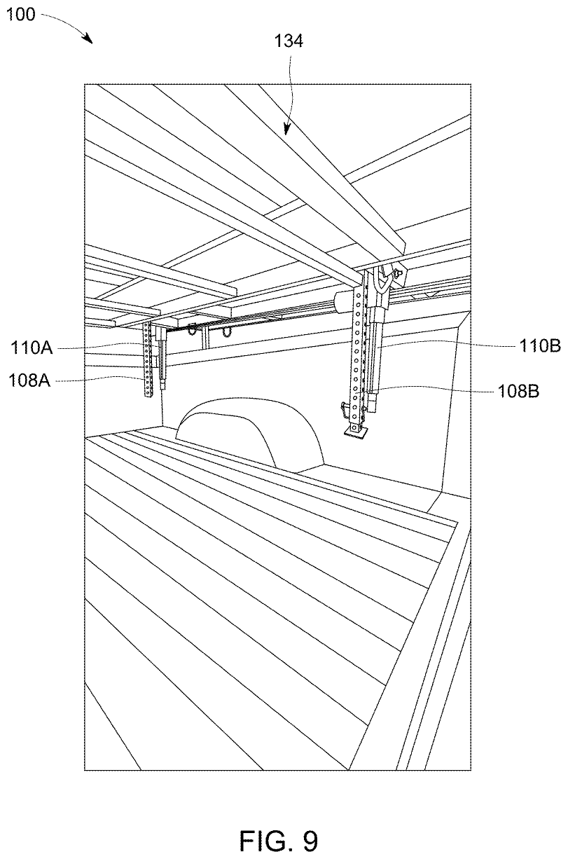

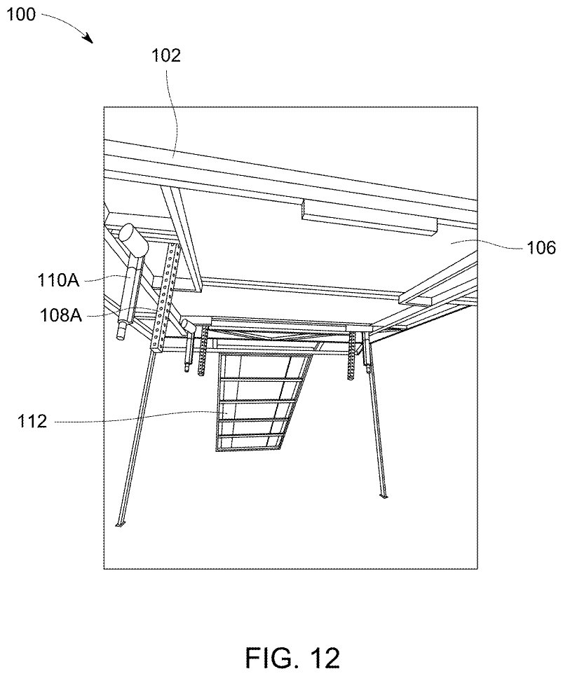

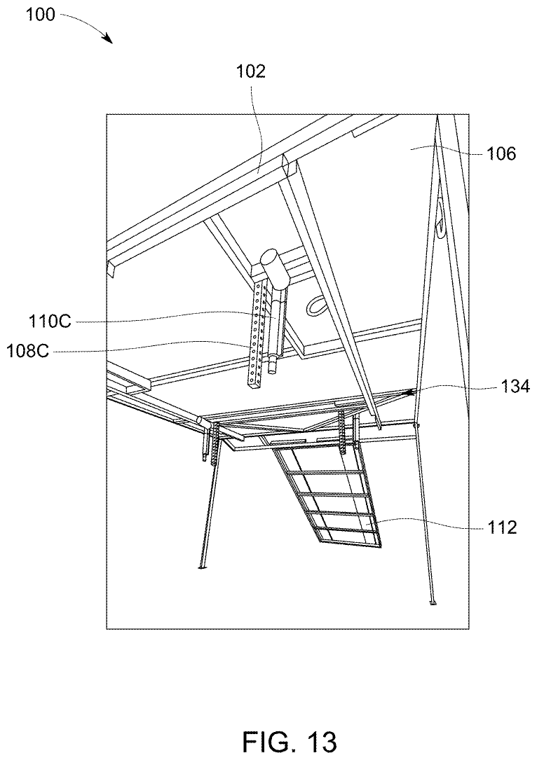

As shown in FIG. 1-14, in one embodiment, an electrically actuated elevating sled deck and cargo system for trucks with dual power options and multi-purpose functionality 100 (hereinafter referred to as the “sled deck”) includes a frame 102, outer legs 104A, 104B, 104C, 104D (FIGS. 4-5) coupleable to sides of the frame 102, a platform 106, inner legs 108A, 108B, 108C, 108D (FIGS. 8-9) and rams 110A, 110B, 110C, 110D (FIGS. 8-9) coupleable to and slidable in relation to a lower surface of the frame 102, and a ramp 112 positionable within the frame 102.

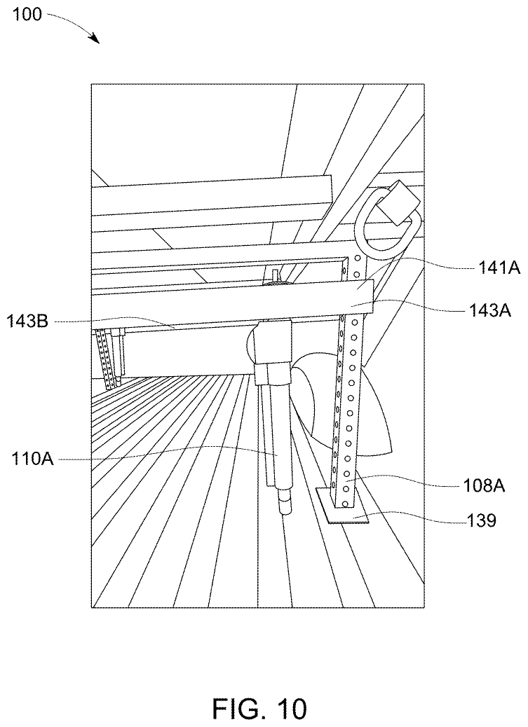

The frame 102 may include a front beam 113, a right-side beam 114 that angles downward towards the rear of the sled deck 100, a left-side beam 116 that mirrors the right-side beam 114 and angles downward towards the rear of the sled deck 100, and a rear beam 118. The frame 102 may also include a headache rack 117 that extends upward from the front beam 113. The headache rack 117 may include crossbeams 119 that add support thereto. The right-side beam 114 may include a first-receiver member 120A (e.g., a D-ring or other similar-type coupler), and the left-side beam 116 may include a second-receiver member 120B (e.g., a D-ring or other similar-type coupler). The first- and second-receiver members 120A, 120B may be configured to receive tie-down straps, ropes, or any other type of fastener that is capable of securing off-road vehicles and/or cargo. While two receivers are shown on the sides, it will be appreciated that more or less than two receivers may be used. Furthermore, the lower surface may include lower-receiver members 122 (FIG. 10) that may be used to secure the sled deck 100 to the truck (in the bed of the truck), or cargo, with tie-down straps, ropes, chains, etc.

The right-side beam 114, at a first end, may include a first fastener 124A having a first panel 126A with a first aperture and coupled to an inner side of the right-side beam 114 and a second panel 126B with a second aperture spaced apart from the first panel 126A and coupled to an outer side of the right-side beam 114. The first and second apertures may receive a first pin 128A (e.g., snap safety pin) or another fastener. The right-side beam 114, at a second end, may include a second fastener 124B having a third panel 126C with a third aperture and coupled to an inner side of the right-side beam 114 and a fourth panel 126D with a fourth aperture spaced apart from the third panel 126C and coupled to an outer side of the right-side beam 114. The third and fourth apertures may receive a second pin 128B (e.g., snap safety pin) or another fastener.

The left-side beam 116, at a first end, may include a third fastener 124C having a fifth panel 126E with a fifth aperture and coupled to an inner side of the left-side beam and a sixth panel 126F with a sixth aperture spaced apart from the fifth panel 126E and coupled to an outer side of the left-side beam 116. The first and second apertures may receive a third pin 128C (e.g., snap safety pin) or another fastener. The left-side beam 116, at a second end, may include a fourth fastener 124D having a seventh panel 126G with a seventh aperture and coupled to an inner side of the left-side beam and an eighth panel 126H with an eighth aperture spaced apart from the seventh panel 126G and coupled to an outer side of the left-side beam 116. The third and fourth apertures may receive a fourth pin 128D (e.g., snap safety pin) or another fastener.

The first, second, third, and fourth fasteners 124A-124D may be configured to receive the outer legs 104A-104D, the first outer leg 104A, the second outer leg 104B, the third outer leg 104C, and the fourth outer leg 104D. While four outer legs are shown, in some embodiments, there may be more or less than four legs. The outer legs 104A may be positioned within each of the four fasteners 124A-124D and more specifically, between the panels 126A-126H on each of the fasteners 124A-124D. A bottom of each of the four outer legs 104A-104D may include a base plate 130A-130D that is secured to the bottom of each leg 104A-104D so as to stabilize each leg 104A-104D. The outer legs 104A-104D may be secured to the fasteners 124A-124D via the pins 128A-128D. The pins 128A-128D may pass through the fasteners 124A-124D and the outer legs 104A-104D, securing the outer legs 104A-104D to the fasteners 124A-124D. The outer legs 104A-104D may be a predetermined height based on the height of the truck bed. The height of each of the outer legs 104A-104D may vary from front to back or side to side, for example. In some embodiments, the outer legs 104A-104D may be adjustable in height. In some embodiments, the outer legs 104A-104D are telescopic, meaning a leg is nested in a leg, making the lower leg extendible. In other embodiments, the outer legs 104A-104D may be foldable against the frame. It will be appreciated that the outer legs 104A-104D may be removably attachable to the frame 102.

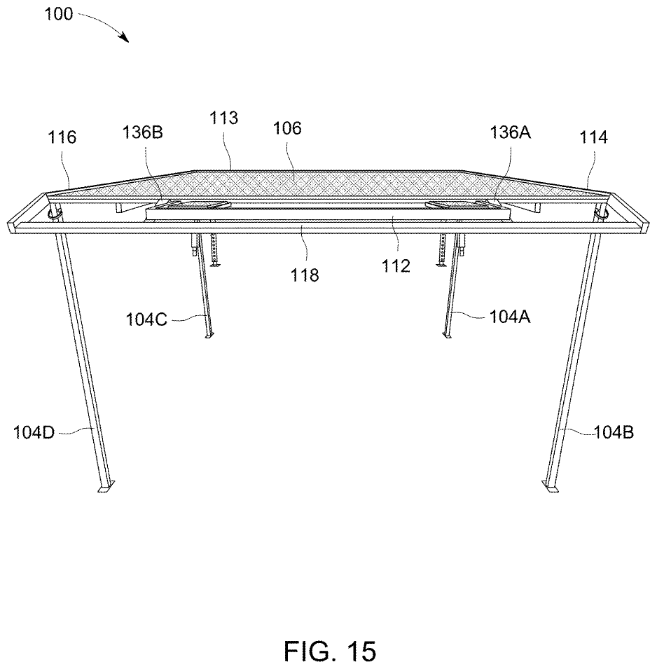

The frame 102 includes a first beam 132A parallel to the left and right-side beams 114, 116 and positioned therein between, and a second beam 132B parallel to the left and right-side beams 114, 116 and positioned therein between. Furthermore, the frame 102 also includes a plurality of cross members 134 that are perpendicular to or at other angles to the right-side beam 114 and the left-side beam 116. Proximate the rear of the frame 102 may be a first support 136A (FIG. 15) and a second support 136B (FIG. 15) that are spaced apart a distance to receive the ramp 112 therein between. The frame 102 may be square steel tubing. In other embodiments, the frame 102 may be rectangular or circular steel tubing. In other embodiments, the frame 102 may be aluminum, fiberglass, wood, or any other material known in the art. The frame 102 may be connected together via welding. Other fastening mechanisms to couple the frame 102 together may include nuts and bolts, pins, some combination thereof, etc.

Coupled to an upper surface of the frame 102 may be the platform 106. The platform 106 may be coupled to the frame 102 via fasteners, such as screws, bolts and nuts, welds, adhesive, or any other securement mechanism. The platform 106 may be plywood, or other sheets of wood. The plywood may, in some embodiments, have a finish that seals the wood. In some embodiments, the platform 106 may be steel, aluminum, fiberglass, wood boards, plastic, or other material(s) used in the art. The platform 106 may be a single segment of material or may be multiple segments combined to cover the upper surface of the frame 102.

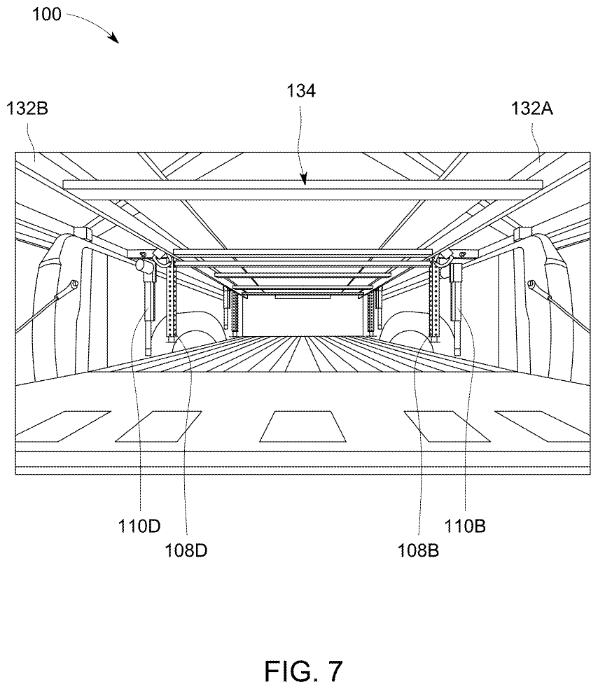

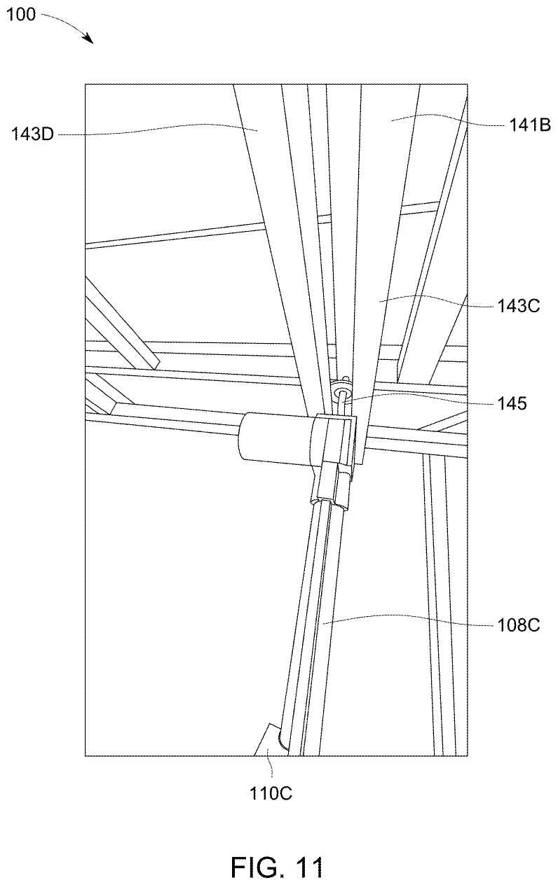

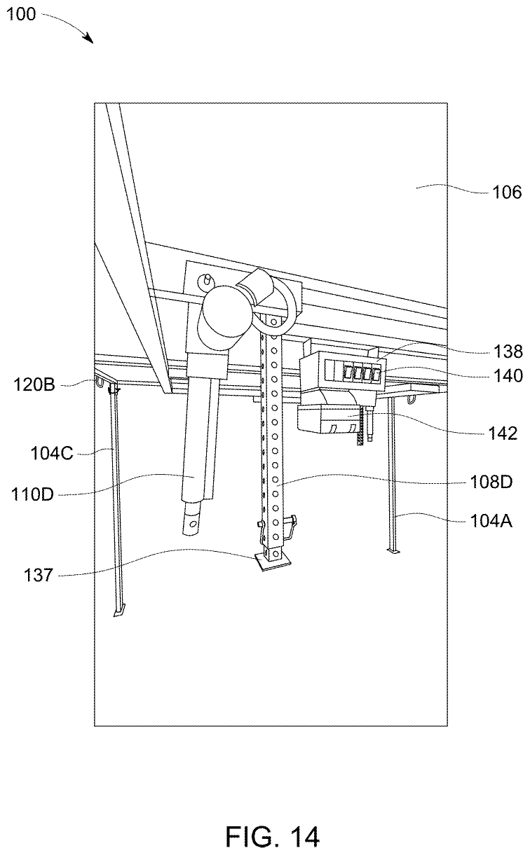

Referring to FIGS. 7-14, a lower surface of the frame 102 may include the inner legs 108A-108D and the rams 110A-110D. The inner legs 108A-108D and the rams 110A-110D may both be removably attachable. In some embodiments, the outer legs 104A-104D, the rams 110A-110D, and/or first and second units discussed herein may be added to any sled deck system, as, for example, an aftermarket upgrade. The inner legs 108A-108D may include a first inner leg 108A, a second inner leg 108B, a third inner leg 108C, and a fourth inner leg 108D. The inner legs 108A-108D may each include a sleeve and an insert 137 (FIG. 14) positionable in the sleeve. The inner legs 108A-108D, meaning the sleeve and the insert 137, may be square sign post tubing, or other types of tubing, shafts, etc. The insert 137 may be a smaller diameter so as to be positioned within the sleeve and slidable on a Y-axis. Each of the inner legs 108A-108D may include a base 139 on the bottom of the insert to assist in stabilizing and bearing any load placed on the platform 106. The inner legs 108A-108D may be adjusted via a pin that passes through each leg. Due to the inner legs having multiple apertures, a user may align the apertures in the sleeve and in the insert to adjust the height to the desired location, and the pin may be inserted to secure the sled deck's height in the bed of the truck. In some embodiments, as shown in FIGS. 10-11, coupled to the inner legs 108A-108D and/or the frame 102 and extending latitudinally therein between may be a first unit 141A with a first shaft 143A and a second shaft 143B proximate the front of the frame 102 extending between the first and second inner legs 108A, 108B and a second unit 141B with a third shaft 143C and a fourth shaft 143D proximate the rear of the frame 102 extending between the third and fourth inner legs 108C, 108D. In some embodiments, the first and second units 141A, 141B may be placed longitudinally in relation to the frame or both latitudinally and longitudinally. In other embodiments, and as shown in the other drawings, the rams 110A-110D may be stationary in one location or in various locations.

The rams 110A-110D may include a first ram 110A, a second ram 110B, a third ram 110C, and a fourth ram 110D. The first and second rams 110A, 110B may be fastened to the first unit 141A, being slidably attachable to and interposed between the first and second shafts 143A, 143B via a coupler 145. The third and fourth rams 110C, 110D may be fastened to the second unit 141B, being slidably attachable to and interposed between the third and fourth shafts 143C, 143D via the coupler 145. The coupler 145 may include an eye bolt, washer, and nut, or it may include any other type of fastening mechanism. With the first and second units 141A, 141B, the rams 110A-110D may slide latitudinally. As such, the rams 110A-110D may be capable of lifting the sled deck 100 from a truck's bed at different positions, meaning the rams 110A-110D may be positioned anywhere along the first and second units 141A, 141B when lifting the sled deck 100. It will be understood the first and second rams 110A, 110B may be coupled to the second unit 141B, and the third and fourth rams 110C, 110D may be coupled to the first unit 141A. The rams 110A-110D may be integrated electric linear actuators. In some embodiments, the rams 110A-110D may use pneumatic means, hydraulic means, airbag lifts, screw lifts, a scissor lift, or some combination thereof or herein discussed. While four inner legs and four rams are shown, it will be understood that there may be more or less than four inner legs and four rams. Each of the rams 110A-110D may be positioned proximate the inner legs 108A-108D, being proximate each corner of the frame 102 (or positioned in other locations along the frame). The rams 110A-110D may be connected to each other via wire and be able to receive communications from a controller 138. The rams 110A-110D may have ram legs that descend via a motor and lift the sled deck 100 so a user can easily and unaided remove or insert the sled deck 100 into a truck. The ram legs may be actuated simultaneously or independently of each other via the controller 138.

The controller 138 may be positioned on the lower surface of the frame 102 or any other location. In some embodiments, the controller 138 may be controlled through a remote or a smart device. The controller 138 may have buttons 140 that actuate the rams 110A-110D. The controller 138 may be powered by a removably attachable battery/power source 142 or the truck's 12-volt trailer plug, creating a dual power source to operate the sled deck 100. In some embodiments, the controller 138 may communicate with each of the rams 110A-110D wirelessly. In some embodiments, the controller 138 may communicate with a smart device so as to allow a user to raise or lower the sled deck via the smart device.

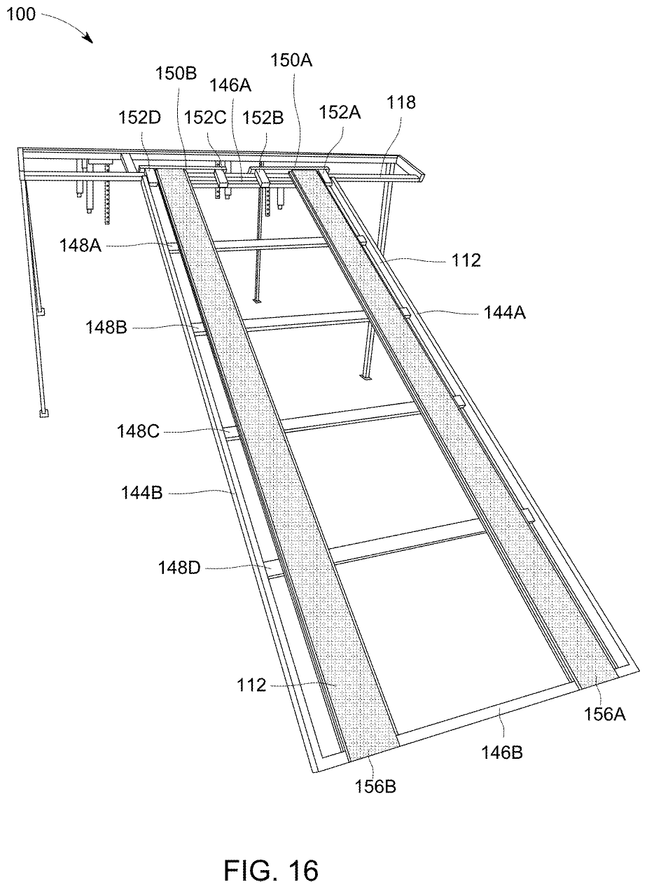

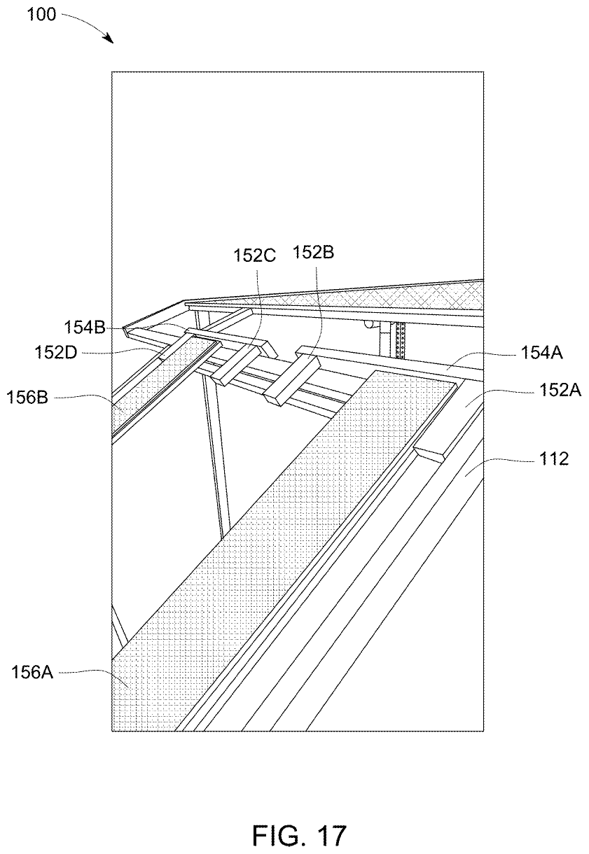

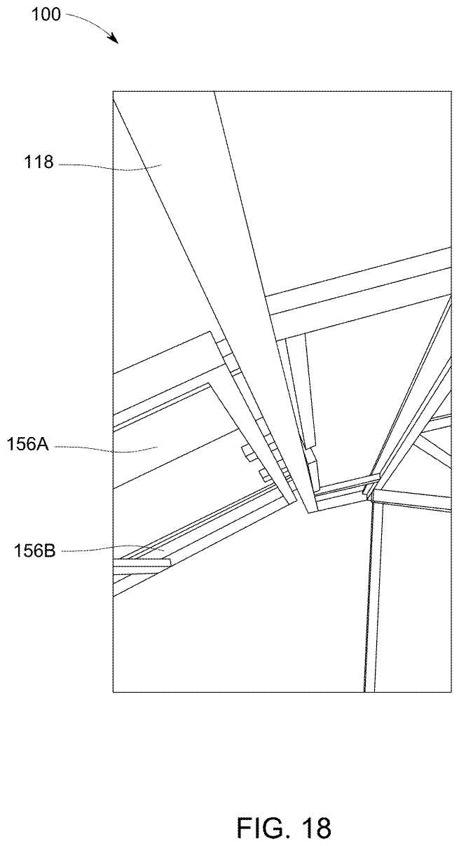

As shown in FIGS. 15-18, to load or unload an off-road vehicle, the user may remove the ramp 112 that is stowed between the first and second supports 136A, 136B and rests upon the plurality of cross members 134. The ramp 112 may be configured to be removably attachable to and rest upon the rear beam 118 of the frame 102. The ramp 112 may comprise a first ramp beam 144A, a second ramp beam 144B parallel to and spaced apart from the first ramp beam 144A, a third ramp beam 146A interposed between, perpendicular to, and coupled to the first ramp beam 144A and the second ramp beam 144B at a first end proximate the platform 106 when coupled to the frame, a fourth ramp beam 146B interposed between, perpendicular to, and coupled to the first ramp beam 144A and the second ramp beam 144B at a second end opposite the first end. Ramp cross beams 148A-148D may extend from the first ramp beam 144A to the second ramp beam 144B. The ramp cross beams 148A-148D may include a first ramp cross beam 148A, a second ramp cross beam 148B, a third ramp cross beam 148C, or a fourth ramp cross beam 148D. While four ramp cross beams 148A-148D are shown, it will be understood that more or less than four may be used.

Coupled to the third ramp beam 146A may be a first member 150A and a second member 150B. The first member 150A may include a first finger 152A and a second finger 152B, both of which are coupled to the third ramp beam 146A. The first and second fingers 152A, 152B may extend outward, away from the third ramp beam 146A. A first tube 154A may be perpendicular to and coupled to the first and second fingers 152A, 152B. The first tube 154A may be taller than the ends of the first and second fingers 152A, 152B, thereby creating a first ledge. Similarly, the second member 150B may include a third finger 152C and a fourth finger 152D, both of which are coupled to the third ramp beam 146A. The third and fourth fingers 152C, 152D may extend outward, away from the third ramp beam 146A. A second tube 154B may be perpendicular to and coupled to the third and fourth fingers 152C, 152D. The second tube 154B may be taller than the ends of the third and fourth fingers 152C, 152D, thereby creating a second ledge. When a user pulls the ramp 112 out from under the platform 106 and from the frame 102, the user may then rest the first and second ledges against a front surface of the rear beam 118, securing the ramp 112 to the sled deck 100. For example, as a user pulls an off-road vehicle onto the ramp 112. The first and second members 150A, 150B hold the ramp 112 onto and against the rear beam 118, allowing the user to drive the off-road vehicle onto or off of the platform 106. The ramp 112 may further include a first panel 156A and a second panel 156B, both of which may be configured to receive the tire or skis of an off-road vehicle. The first and second panels 156A, 156B may be secured to an upper surface of the ramp 112 and spaced apart a distance to match off-road vehicle tire or ski widths. The first and second panels 156A, 156B may include a first material, such as rubber sheets, or another gripping material, attached to the first and second panels 156A, 156B to add grip thereto for the off-road vehicles. In some embodiments, a single panel or more than two may be used.

It will be appreciated that the sled deck 100 allows a single user to load or off load the sled deck 100 via the rams 110A-110D. Furthermore, the sled deck 100 provides a significant improvement for managing decks, offering a self-contained lifting mechanism for truck removal after unloading, dual power options, and potential for temporary storage. After the sled deck 100 is removed from the truck, it may function as storage or a canopy to store cargo or off-road vehicles thereunder, giving the sled deck 100 multiple functions. When the sled deck 100 is removed from the truck, to create the canopy, a user may wrap the sled deck 100 with canvas or another material to fully enclose any items or vehicles placed under the sled deck 100.

In one embodiment, a method of using the sled deck 100 may include a user placing cargo on the sled deck 100. In particular, with the sled deck 100 on the truck, deploy the ramp 112, load and secure cargo, then stow the ramp 112. To remove the sled deck 100, unload all cargo from the sled deck 100 and activate the power source 142 to engage the rams 110A-110D to lift the sled deck 100. The outer legs 104A-104D are positioned to support the sled deck 100. The user then transfers the truck away from the sled deck 100. Attach side coverings to the sled deck 100, if desired. To load the sled deck 100, a user may position the truck under the supported, empty sled deck 100, remove outer legs 104A-104D, and lower the sled deck 100 onto the truck bed. The user may load or unload cargo onto the platform 106 by utilizing the stowable ramp 112.

It will be understood that while various embodiments have been disclosed herein, other embodiments are contemplated. Further, certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure. The embodiments described herein are examples of the present disclosure. Accordingly, unless a feature or component is described as requiring another feature or component in combination therewith, any feature herein may be combined with any other feature of a same or different embodiment disclosed herein. Although only a few of the example embodiments have been described in detail herein, those skilled in the art will appreciate that modifications are possible without materially departing from the present disclosure described herein. Accordingly, all modifications may be included within the scope of this invention.

What is claimed is:

1. An electrically actuated elevating sled deck and cargo system for trucks with dual power options and multi-purpose functionality, the system comprising:
a frame;
a plurality of outer legs coupleable to sides of the frame;
a platform fastened to the frame;
a plurality of inner legs;
a plurality of rams; and
a ramp positionable within the frame;
wherein the plurality of inner legs and rams are coupleable to a lower surface of the frame.

2. The system of claim 1, wherein the frame comprises a front beam, a right-side beam, a left-side beam parallel to the right-side beam, and a rear beam that is parallel to the front beam.

3. The system of claim 2, wherein the right-side beam and the left-side beam are both angled downward toward a rear of the sled deck.

4. The system of claim 1, wherein the frame comprises a plurality of receiver members.

5. The system of claim 1, wherein the frame comprises a plurality of fasteners that receive the plurality of outer legs.

6. The system of claim 4, wherein the plurality of receiver members comprises a first-receiver member, a second-receiver member, and lower-receiver members.

7. The system of claim 5, wherein the plurality of fasteners each comprise a first panel with a first aperture and a second panel with a second aperture.

8. The system of claim 7, wherein the first and second apertures receive a pin.

9. The system of claim 1, wherein a bottom of each of the plurality of outer legs comprises a base plate.

10. The system of claim 1, wherein each of the plurality of outer legs are adjustable on a Y-axis.

11. The system of claim 1, further comprising support beams positioned within the frame.

12. The system of claim 1, wherein each of the plurality of inner legs comprises an insert, adjustable on a Y-axis within the bed of a truck.

13. The system of claim 1, further comprising a controller to communicate with the plurality of rams.

14. The system of claim 1, wherein the ramp is removably attachable to the frame.

15. The system of claim 14, wherein the ramp is positioned on a plurality of cross members positioned beneath the frame.

16. An electrically actuated elevating sled deck and cargo system for trucks with dual power options and multi-purpose functionality, the system comprising:
a frame comprising:
a front beam, a right-side beam, a left-side beam parallel to the right-side beam, and a rear beam that is parallel to the front beam;
a plurality of outer legs coupleable to sides of the frame via fasteners, the plurality of outer legs comprising:
a first-outer leg with a first-base plate, a second-outer leg with a second-base plate, a third-outer leg with a third-base plate, and a fourth-outer leg with a fourth-base plate;
a platform fastened to the frame;
a plurality of inner legs positioned below the frame and the platform, wherein the inner legs rest on a truck's bed;
a plurality of rams positioned proximate the plurality of inner legs, the plurality of rams coupled to first and second units; and
a ramp positionable within the frame, the ramp comprising:
a first panel and a second panel,
a first member, and
a second member;
wherein the first and second members are removably attachable to the rear beam when loading and unloading the sled deck.

17. The system of claim 16, wherein each of the plurality of rams are actuated via a controller.

18. The system of claim 17, wherein the controller communicates with the plurality of rams via wire or wireless communication.

19. The system of claim 16, wherein the first member and the second members both comprise fingers that are removably attachable to a rear of the frame.

20. An electrically actuated elevating sled deck and cargo system for trucks with dual power options and multi-purpose functionality, the system comprising:
a frame comprising:
a front beam, a right-side beam, a left-side beam parallel to the right-side beam, and a rear beam that is parallel to the front beam;
a plurality of outer legs coupleable to sides of the frame via fasteners, the plurality of outer legs comprising:
a first-outer leg with a first-base plate, a second-outer leg with a second-base plate, a third-outer leg with a third-base plate, and a fourth-outer leg with a fourth-base plate;
a platform fastened to the frame;
a plurality of inner legs positioned below the frame and the platform, wherein the inner legs rest on a truck's bed;
a plurality of rams positioned proximate the plurality of inner legs; and
a ramp positionable within the frame, the ramp comprising:
a first panel and a second panel,
a first member comprising a first finger, a second finger, and a first tube perpendicular to and interposed between the first and second fingers, and
a second member comprising a third finger, a fourth finger, and a second tube perpendicular to and interposed between the third and fourth fingers;
a controller;
wherein the plurality of inner legs and rams are coupleable to a lower surface of the frame.
